(19) United States
(12) Patent Application Publication
(10) Pub. No.: US 2012/0308854 A1
(43) Pub. Date: Dec. 6, 2012

(54) ELECTROCHEMICAL ENERGY STORE AND METHOD FOR THERMALLY STABILIZING AN ELECTROCHEMICAL ENERGY STORE

(75) Inventors: Tim Schaefer, Harztor (DE); Andreas Gutsch, Luedinghausen (DE)

(73) Assignee: LI-TEC BATTERY GMBH, Kamenz (DE)

(21) Appl. No.: 13/504,934

(22) PCT Filed: Oct. 22, 2010
(86) PCT No.: PCT/EP10/06475

§ 371 Date: Aug. 21, 2012

(30) Foreign Application Priority Data
Oct. 29, 2009 (DE) 10 2009 051 216.0

(51) Int. Cl. H01M 10/50; H01M 10/48

(52) U.S. Cl. 429/50; 429/120; 429/62

(57) ABSTRACT

In an electrochemical energy store including at least one spatially delimited galvanic cell, said galvanic cell includes a component or a device which causes the level of heat generated within the galvanic cell to drop to or below the level of heat dissipated from the cell beyond the spatial boundaries of the cell when a threshold temperature inside the galvanic cell is at least locally exceeded.

### CROSS-REFERENCE TO RELATED APPLICATIONS

This application is a national stage application under 35 U.S.C. §371 of International Application No. PCT/EP2010/006475, filed Oct. 22, 2010 and published as WO 2011/050930, which claims priority to German patent application number DE 10 2009 051 216.0, filed Oct. 29, 2009, the entirety of each of which is hereby incorporated herein by reference.

### SUMMARY

The present invention relates to an electrochemical energy store and a method for thermally stabilizing an electrochemical energy store, particularly a lithium ion rechargeable battery.

Various approaches to solving the problem of thermally stabilizing an electrochemical energy store are known from the prior art. U.S. Pat. No. 5,574,355 A describes a device for detecting “thermal runaway” for use when charging batteries. This device includes a switching circuit for determining the internal resistance or conductance of a battery. A switching circuit detects a rise in a battery's internal conductance or a fall in its internal resistance, and generates a corresponding output signal. This output signal indicates that a thermal runaway condition exists or is imminent in this battery. The switching circuit may be used to control the charging operation for the battery.

U.S. Pat. No. 5,642,100 A describes an energy management system, a method and a device for controlling thermal runaway in the battery of a telecommunications switching station or a battery charging system connected therewith. The system receives current from a power supply and delivers the current through a rectifier to a battery and a load. The system has a low-voltage disconnect switch, with which the battery may be disconnected from the current. A resistance sensor serves to generate a first signal, which represents the current flow through the rectifier. A second resistance sensor is used to generate a second signal, which represents the current flow through the load. A third value is generated with the aid of a microprocessor, and this value represents the difference between the first and second signals. The microprocessor is also used to generate a signal that warns of a thermal runaway condition when the third value exceeds a predetermined threshold value. In this case, the battery may be disconnected from the current.

U.S. Pat. No. 5,710,507 A describes a switching circuit and a method for using the circuit to select the operating mode of a charging circuit for reserve battery. The circuit for selecting the operating mode includes a transducer for converting a temperature value (temperature transducer) which is connected to the reserve battery in order to measure the temperature of the reserve battery. The circuit also includes a mode-changing circuit that is coupled to the temperature transducer to allow a selection to be made between a heating mode and a charging mode. In the heating mode, the reserve battery is heated by an external power supply. In the charging mode, the energy source is used to charge the battery.

U.S. Pat. No. 7,061,208 B2 describes a temperature regulator for regulating the temperature of a storage battery. This regulator contains a thermoelectric transducer having two contact points. The first contact point is thermally coupled with one or more storage batteries, and the second interface is thermally coupled with a thermal action accelerating medium that accelerates thermal action of the second interface. The first interface and the second interface fulfill opposite functions to one another, that is to say they perform heat dissipation or heat absorption depending on the polarity of the battery. This structure allows the temperature regulator to cool the storage battery down or heat it up.

These various, known products and methods are each associated with various drawbacks. The object underlying the present invention is to suggest the most effective method possible for thermally stabilizing an electrochemical energy store and a corresponding energy store.

This is achieved according to the present invention as described herein.

The electrochemical energy store according to the present invention comprises at least one galvanic cell that contains or includes a component or device which causes the heat production inside the galvanic cell to be reduced at least temporarily and/or the heat dissipation from this cell to the surrounding atmosphere to be increased at least temporarily if a limit temperature inside the galvanic cell is at least locally exceeded.

In the method for thermally stabilizing an electrochemical energy store according to the present invention comprising at least one galvanic cell, a component or device contained or included in this galvanic cell causes the heat production inside the galvanic cell to be reduced at least temporarily and/or the heat dissipation from this cell to the surrounding atmosphere to be increased at least temporarily if a limit temperature inside the galvanic cell is at least locally exceeded.

The component or device provided according to the present invention that causes the heat production inside the galvanic cell to be reduced at least temporarily and/or the heat dissipation from this cell to the surrounding atmosphere to be increased at least temporarily if a limit temperature inside the galvanic cell is at least locally exceeded may be for example a chemical substance or a mixture of substances located inside the galvanic cell in the dissolved or undissolved state, preferably arranged in one of the structures that constitute the components of the cell that are themselves electrochemically active or support or enable the electrochemical processes, for example in or at that electrodes, the separators, or in the electrolyte. However, it may also be a structural component or device, such as a preferably electromechanical, electronic or mechatronic component or device that is preferably controlled by a measurement signal for the temperature of the cell and is able for example to release a substance or for example open or close transport channels for transporting substances within the cell, and in this way or by some other manner cause the heat production inside the galvanic cell to fall to or below the level of heat dissipated from this cell beyond its spatial boundaries.

With regard to the description of the present invention, the term electrochemical energy store is intended to mean any kind of energy store from which electrical energy can be drawn, wherein an electrochemical reaction takes place inside the energy store. The term particularly includes all types of galvanic cells, particularly primary cells, secondary cells and arrangements whereby such cells are connected to create batteries. Energy stores of such kind are usually equipped with negative and positive electrodes that are separated by a “separator”. Ions are transported between the electrodes via an electrolyte. However, the term electrochemical store is also intended to refer to fuel cells.

In this context, the term thermal stabilization of an electrochemical energy store is intended to mean any and all measures designed to protect the electrochemical store from impairment or damage that might be caused if a limit temperature inside the electrochemical store were exceeded at least locally. Exceeding a limit temperature at least locally is understood to mean a trend in the temperature or temperature distribution over time that causes a limit temperature to be exceeded temporarily or permanently at one location or in a spatial subarea inside the electrochemical store.

In this context, the term heat production inside the galvanic cell or the electrochemical store is intended to refer to the quantity of heat per unit of time that is generated inside the galvanic cell or the electrochemical store, for example as the heat of a chemical reaction or due to other dissipative processes. Heat production should not be confused with the dissipation of heat emission from a galvanic cell or electrochemical energy store to the ambient atmosphere. This is caused by heat fluxes over the outer limits of a galvanic cell or electrochemical energy store.

Under certain circumstances, heat production may assume negative values, for example when an endothermic reaction takes place inside a galvanic cell or electrochemical energy store, or, for example, there is a heat sink inside a galvanic cell or electrochemical energy store. Regardless of the above, the term heat production is used without reference to the sign that precedes this value. Similarly, heat can be transported not only outwards from inside a galvanic cell or electrochemical energy store but also in the opposite direction, for example in situations where a galvanic cell takes up heat from an adjacent galvanic cell. In these cases, heat dissipation is measured in negative values, which evidently indicates that heat is being absorbed. Therefore, the term heat dissipation is understood to include the case of heat absorption also.

Advantageous embodiments and refinements of the present invention represent the objects of the subordinate claims.

In a preferred electrochemical energy store or a preferred method for thermally stabilizing an electrochemical energy store, at least one chemical reaction or at least one chemical reaction or at least one substance transport action inside a galvanic cell of the electrochemical store is influenced at least locally in such manner that heat production inside the galvanic cell falls down to or below the level of heat dissipation from this cell beyond the spatial boundaries thereof. Control of the heat production may often be exercised relatively quickly by influencing chemical reactions or substance transport flows, resulting in rapid, effective thermal stabilization of an electrochemical energy store. In this way, thermal stabilization is enabled even in extreme situations, for example if a “thermal runaway” condition is imminent or actually in progress, in which a self-accelerating increase in the temperature inside an electrochemical energy store threatens to destroy it.

In a further preferred electrochemical energy store or a further preferred method for thermally stabilizing an electrochemical energy store, at least one chemical reaction or at least one substance transport action inside the galvanic cell is at least locally inhibited, that is to say suppressed, restricted or prevented. The at least local suppression, restriction or prevention of a chemical reaction results in particularly effective thermal stabilization of an electrochemical energy store in particular if the reaction in question is an exothermic chemical reaction, or a chemical reaction the product of which the product of which is also a reactant in an exothermic reaction taking place inside the galvanic cell.

A chemical reaction or substance transport action inside the galvanic cell is preferably inhibited by suitable separator materials and/or separator structures, which for example influence the flow of ions according to the local temperature or the strength of the local ion flow. Such separator materials or separator structures are preferably made from a porous or microporous carrier with a coating of materials that lower the transport of ions through the pores above a limit temperature.

As another solution, also preferred alternatively to or in combination with such measures, it would be conceivable to apply a coating to the electrodes, that is to say the anodes or the cathodes, which coating consists of materials that lower the transport of ions through the pores above a limit temperature.

Such embodiments of the present invention may preferably also be combined with further embodiments, in which thermal fuses are used to electrically isolate a galvanic cell from its surroundings if overheating becomes imminent, or with heat pumps, for example Peltier type heat pumps, which have one hot and one cold heat transfer point and preferably one semiconductor element that transports heat energy between the two heat transfer points. Other preferred measures that may be implemented alternatively or in combination may be power disconnectors or power limiters with the aid of current sensors for measuring the battery current. With a combination of these and similar devices, it is possible to significantly improve thermal stabilization of an electrochemical energy store compared with the corresponding measures used individually.

In a further preferred electrochemical energy store or a further preferred method for thermally stabilizing an electrochemical energy store, the thermal conductivity inside the galvanic cell is temporarily or permanently increased at least locally. This may also be effected preferably with heat pumps, for example with Peltier type heat pumps, which are then arranged in the galvanic cell in such manner that effective heat transport is enabled and at the same time these heat pumps are largely or entirely prevented from exchanging substances with the other cell components. By such means,—preferably also in combination with other embodiments of the present invention—the transport of heat from the interior of the galvanic cell to its spatial limits may be increased, thus also increasing the dissipation of heat from this cell to the surrounding atmosphere.

In a further preferred electrochemical energy store or a further preferred method for thermally stabilizing an electrochemical energy store, the heat dissipation from this cell beyond the spatial boundaries thereof is temporarily or permanently increased at least locally. In this case too, preferably heat pumps, for example Peltier type heat pumps may be used to advantage.

Such heat pumps may be controlled in conjunction with all embodiments of the present invention described in the foregoing preferably by means of sensor signals combined with microprocessors, for example by the signals from temperature sensors or from sensors for measuring the current delivered or consumed by the energy store or its cells.

Someone skilled in the art would know to combine certain of the described embodiments of the present invention based on this technical knowledge; other embodiments, which cannot be described exhaustively here, would be readily discovered by someone skilled in the art based on his technical knowledge and with reference to the present description. The present invention is not limited to the embodiments described herein.

In the following, the present invention will be described in greater detail on the basis of preferred embodiments thereof and with reference to the drawing.

### BRIEF DESCRIPTION OF THE DRAWINGS

FIG. 1 is a schematic representation of heat production inside an electrochemical energy store having a galvanic cell and heat dissipation therefrom.

FIG. 2 is a schematic representation of heat production inside an electrochemical energy store having multiple galvanic cells and the heat transport conditions therein.

FIG. 3 is a schematic representation of an electrochemical energy store having a stack of multiple electrodes separated by a separator.

FIG. 4 is a schematic representation of the ion transport processes and heat transport processes inside an electrochemical energy store in normal operation.

FIG. 5 is a schematic representation of the ion transport processes and heat transport processes inside an electrochemical energy store in an operating mode with locally increased ion transport.

FIG. 6 is a schematic representation of a preferred embodiment of an electrochemical energy store according to the present invention with locally inhibited ion transport and/or a locally inhibited chemical reaction.

FIG. 7 is a schematic representation of a preferred embodiment of an electrochemical energy store according to the present invention with locally increased heat conductivity inside the galvanic cell.

FIG. 8 is a schematic representation of a preferred embodiment of an electrochemical energy store according to the present invention with locally increased heat conductivity inside the galvanic cell and locally increased heat dissipation through the outer boundaries of the galvanic cell.

### DETAILED DESCRIPTION

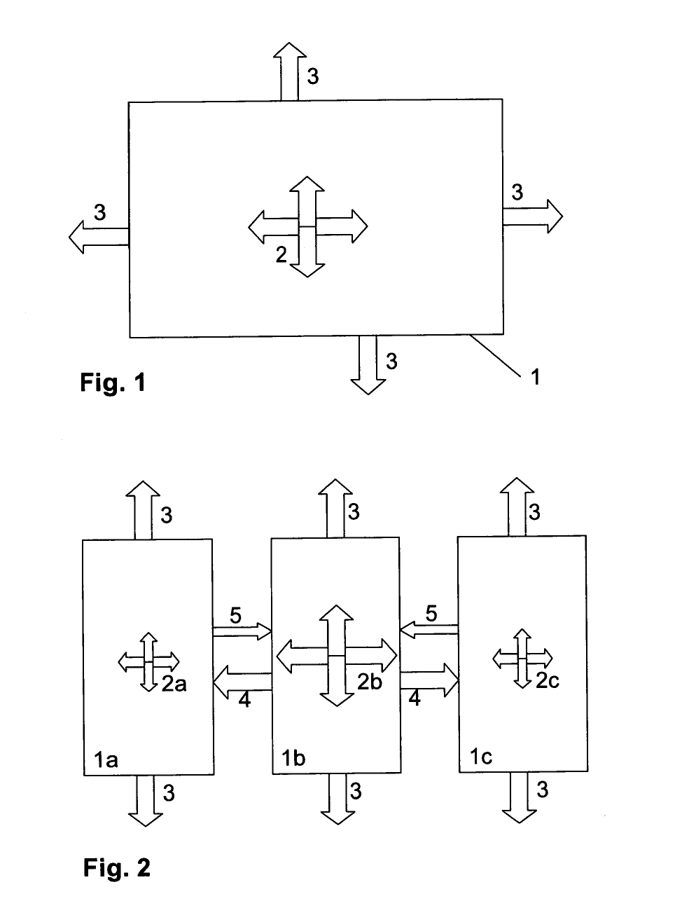

As is shown schematically in FIG. 1, heat production 2 is generated inside a galvanic cell 1 as the heat from exothermic chemical reactions or due to other dissipative processes, and is associated with a rise in temperature inside the galvanic cell, if the heat produced is not dissipated through the outer boundaries 1 of the galvanic cell via a sufficiently large heat sink 3. In such circumstances, the temperature rises if and for as long as heat is produced more quickly than it is dissipated The temperature falls if and for as long as heat is produced more slowly than it is dissipated, and it remains constant if and for as long as the rates of heat production and dissipation are equal.

Heat dissipation 3 from a galvanic cell via its outer boundaries is essentially determined by the temperature of the galvanic cell in the area of the outer boundaries, that is to say for example by the temperature of the packaging film or the temperature of the housing. However, heat production 2 in the interior of a galvanic cell initially raises the temperature inside that galvanic cell. Heat transport processes inside the galvanic cell, the range and magnitude of which are essentially determined by the thermal conductivity and in some cases also by other phenomena, such as convection flows, bring about a temperature equalization inside the galvanic cell, as a consequence of which the temperature in the interior of the galvanic cell approaches the temperature at the boundaries of the cell. However, this process does not take place instantaneously, it is usually associated with delays, the delay periods depending on the thermal conductivity properties of the material in the interior of the galvanic cell.

Particularly when a “thermal runaway” condition is imminent or in progress, that is to say for example when rapid exothermic chemical reactions are taking place inside the cell, the heat transport processes inside the galvanic cell are often not sufficient to prevent the temperature in the interior of the galvanic cell from rising above a critical limit temperature.

In batteries comprising a plurality of galvanic cells, such as is represented schematically in FIG. 2, this situation is further complicated by the fact that the cells exchange heat fluxes 4, 5 via adjacent cell boundaries. For example, if the heat production 2b inside a galvanic cell lb with adjacent cells 1a, 1c is greater than the heat production 2a, 2c in the adjacent cells, thermal flows 4 from the hotter cell 1b to the colder cells 1a, 1c will at least eventually exceed the thermal flows from the colder cells to the warmer cell. Consequently, heat is transferred to adjacent cells 1a, 1c, which may also cause adjacent cells 1a, 1c to overheat, even though the heat production 2a, 2c in these adjacent cells would not be sufficient on its own to cause overheating in these cells. As a result of these effects, it is possible for an overheating cell to cause its neighbouring cells to overheat also, so that a single cell in a thermal runaway condition may also induce a thermal runaway condition in several adjacent cells through a cascade effect.

In order to avoid the dangers of overheated galvanic cells in electrochemical energy stores associated with this phenomenon, the present invention provides that an electrochemical energy store having at least one spatially delimited galvanic cell comprises or includes a component or device that causes the heat production inside the galvanic cell to fall down to or below the level of heat dissipation in this cell via its spatial boundaries when a limit temperature is exceeded at least locally inside the galvanic cell.

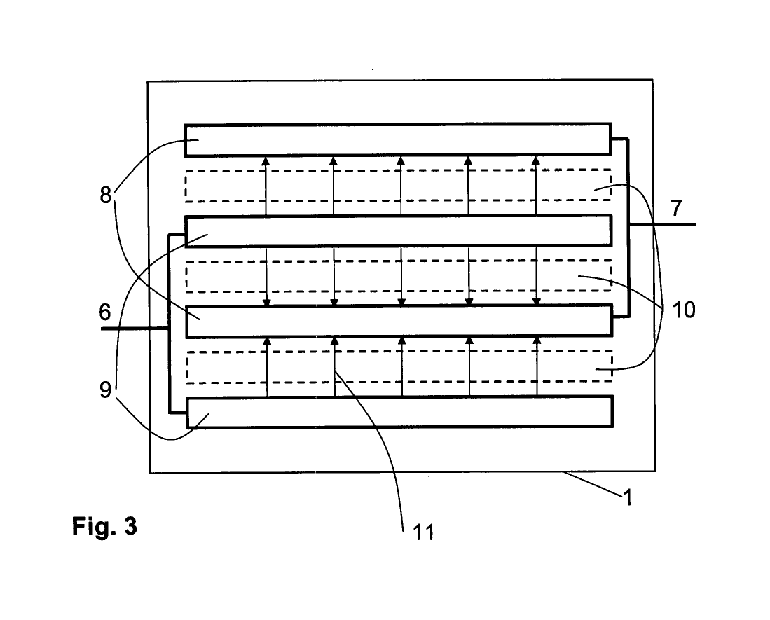

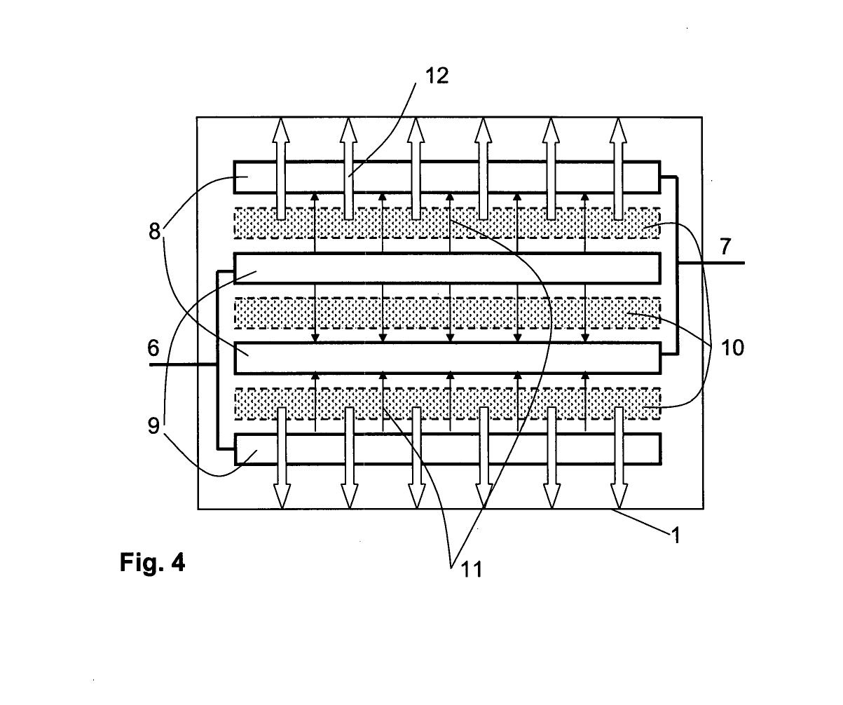

FIG. 3 is a schematic representation of a galvanic cell having an electrode stack of positive electrodes 8 and negative electrodes 9 with separators 10 interposed between them to prevent a short circuit inside the galvanic cell. A stream of ions 11 flows through the separators and is matched by a stream of electrons flowing between current collectors 6, 7.

As in shown schematically in FIG. 4, these ion streams 11 between the electrodes and through separators 10 cause heat production and corresponding heat transport processes 12 from the interior to the boundaries of the galvanic cell. When a galvanic cell is operating normally heat dissipation 3, that is to say the thermal fluxes through the outer boundaries of the galvanic cell from the inside to the surrounding atmosphere, is sufficient to ensure that the temperature in the cell does not rise to critical values.

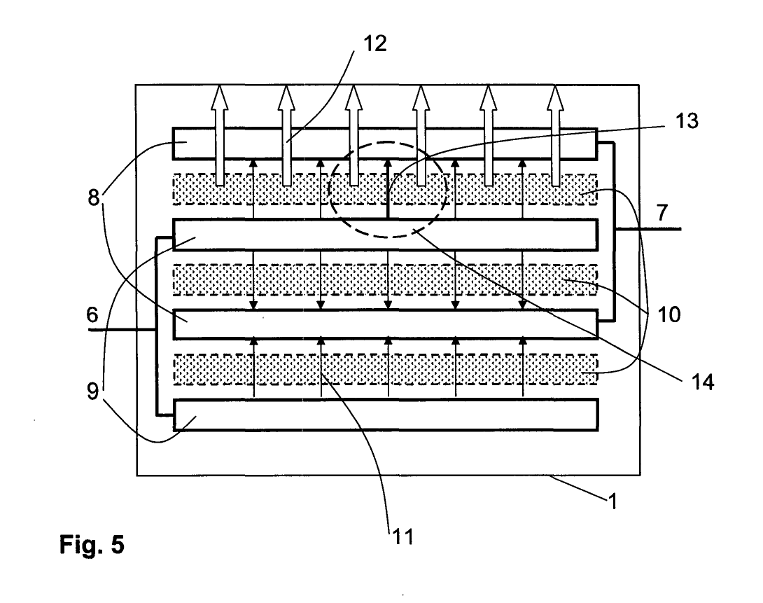

However, local increases 13 in the density of the ion stream or local accelerations in the rate of electrochemical reactions 13 may be caused by various disturbances inside a galvanic cell, and may cause a local increase in the temperature at the affected site 14. This situation is shown schematically in FIG. 5. If this situation persists for prolonged periods and if the heat dissipation 12 is not increased correspondingly, the temperature at the affected site 14 continues to rise, and consequently rises in other areas of the cell as well. At this point, whether the temperature will rise above the critical limit or not depends on the speed of the associated dissipative processes.

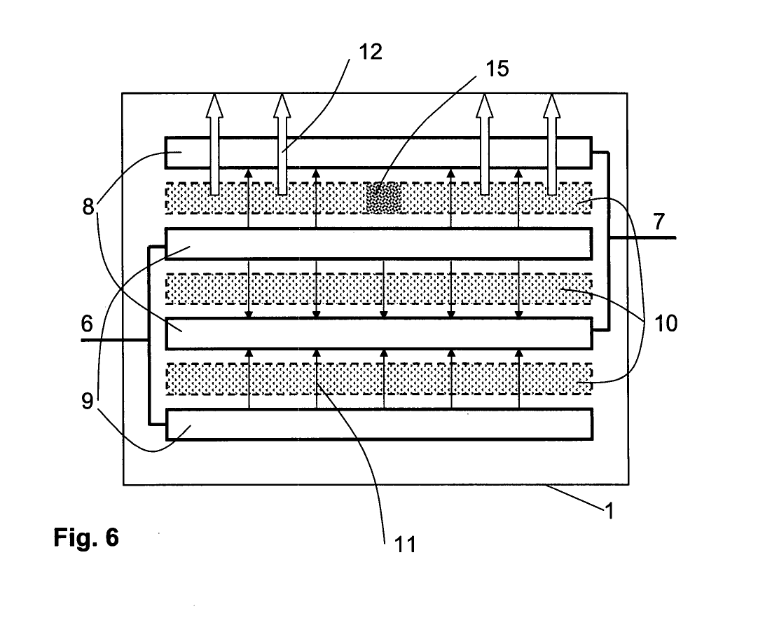

FIG. 6 is a schematic representation of a preferred embodiment of an electronic energy store according to the present invention having locally inhibited ion transport 15 and/or locally inhibited chemical reaction 15. To this extent, FIG. 6 illustrates an entire class of embodiments of the present invention that differ from each other in the mechanism that is employed to inhibit the chemical reaction or a transport process. This inhibition may be assured in widely differing ways.

A first option consists in accommodating the substance for disrupting the proper cell reaction in the galvanic cell in such manner that the substance is not effective during normal operation. This may be effected for example by enclosing this reagent in a thermoplastic encapsulating material that is disposed close to the battery electrodes or inside the separator structures. By selecting the melting point of the thermoplastic encapsulating material appropriately, it is possible to ensure that the reagent for disrupting the electrochemical cell reaction is released by melting of the thermoplastic material when the temperature in the cell interior exceeds a given limit value, that is to say the melting point of the material.

Another option consists in making the release of the disrupting reagent dependent on the magnitude of the ion stream. This embodiment of the present invention has the advantage that it is possible to inhibit the chemical reaction that would cause the temperature to rise even before this temperature increase has reached a critical value. In this way, the problem of delayed temperature equalization within the cell is avoided or alleviated. This embodiment of the present invention may be produced particularly advantageously if a coating with capsules containing disruptive reagent is applied to the electrodes and the capsules release the reagent when the ion stream over this electrode exceeds a given value.

Another option for locally inhibiting the cell reaction consists in the use of electrolytes that are not liquid but, for example, are in gel form. By appropriate selection of the chemical composition of such gel-phase electrolytes, it is possible to keep the ion conductivity of such an electrolyte high below a limit temperature, and to allow the ion conductivity of the electrolyte to fall to such an extent when a limit temperature is reached or exceeded that the electrolyte practically functions as an insulator when this temperature is reached or exceeded. When such gel-phase or other non-liquid or viscous electrolytes are used, it is possible to suppress the electrochemical cell reaction locally to such an extent that heat is prevented from spreading any further through the cell. Examples of substances that are particularly suitable for these purposes are non-liquid or viscous electrolytes that contain a dispersion of an inert material that prevents ion transport. Organic polymers are preferred examples of such.

A further option for inhibiting the cell reaction in a galvanic cell consists in constructing the separator as a porous substrate and furnishing preferably one of the surfaces thereof with a material that melts under the effects of heat. The thermally meltable material is preferably applied to the surface of the separator in such manner that open areas are left, in which ion transport may take place. This may be achieved for example by applying the thermally meltable material to the separator in matrix-like manner. This thermally meltable material then melts at or close to a predetermined limit temperature, with the result that the ion-permeability of the substrate on the separator is significantly reduced, thus effectively inhibiting the cell reaction of the galvanic cell.

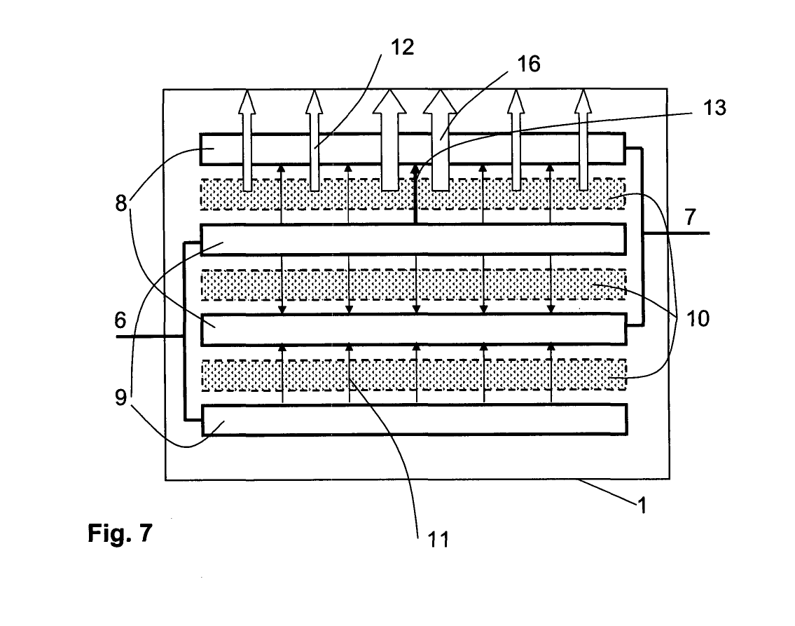

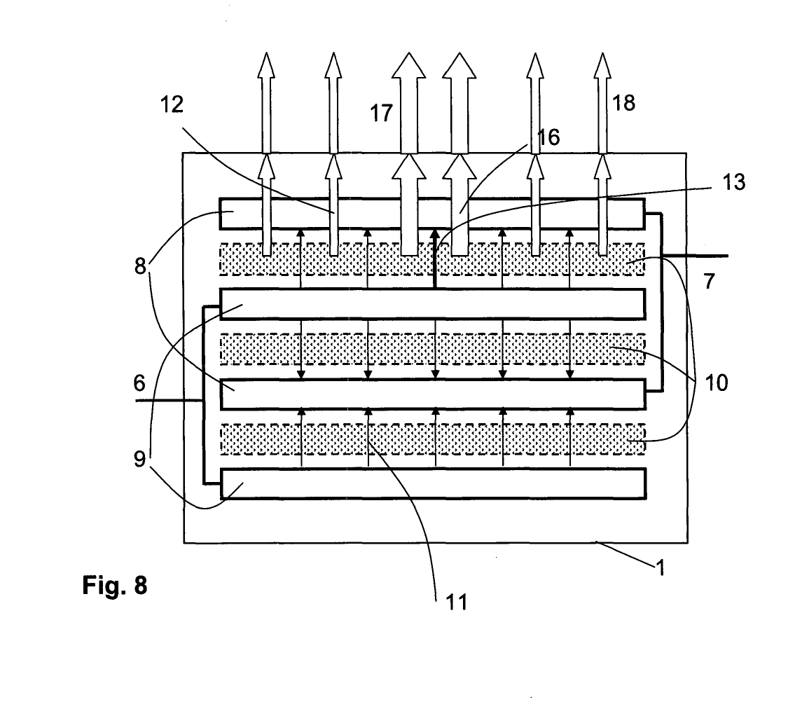

FIG. 7 illustrates a further class of exemplary embodiments of the present invention, the features of which may also be implemented in combination with the features of other embodiments. In this class of embodiments, the locally increased quantity of heat energy produced is dissipated locally at an increased rate with the aid of locally increased thermal conductivity in the interior of the galvanic cell.

One option for producing these embodiments of the present invention consists in placing materials inside the cell, the thermal conductivity of which increases as the temperature rises. A relatively large number of such materials are known and have been thoroughly researched. In this context, the materials selected are preferably those that are chemically inert with respect to the active components of the galvanic cell. Such materials may preferably be mixed with the other components of the galvanic cell as a dispersion or a solution. However, it is also possible to mix such materials into the separator structure, for example, so that the thermal conductivity of a separator prepared in this way increases as the temperature rises. In this way, it is possible to increase the heat dissipation and the heat transport of the galvanic cell as the temperature rises, thereby counteracting continued rising of the temperature in the cell interior.

A further option for increasing thermal conductivity inside the galvanic cell as the temperature rises consists in disposing suitable heat pumps, for example Peltier type heat pumps, in suitable manner in the cell, which are then able to transport heat actively. Heat pumps of such kind may be controller by sensor signals with the aid of microprocessors, these sensor signals preferably representing temperatures measured in the cell interior. The power supply for such heat pumps might preferably be taken from the galvanic cell to be stabilized itself via its electrodes or its electrical connecting terminals.

Heat pumps, particularly of the Peltier type, may preferably also be used to improve heat dissipation via the outer boundaries of the cell. Such embodiments of the present invention, which may also be used in combination with the features of other embodiments, are illustrated by the diagram in FIG. 8. In the area of elevated temperature 13, caused for example by increased ion transport at this site, heat transport 16 in the cell interior is increased towards the outer boundaries of the cell. In these embodiments of the present invention, more and more of the heat that is transported to the outer boundaries of the cell is now dissipated 17 through the outer boundaries by suitable means. In this way, greater heat dissipation 17 is realized at the outer boundaries of the cell than at other areas of the cell boundaries 18.

One possible way to achieve this is to use heat pumps, particularly of the Peltier type, to improve heat transport at the cell boundaries. Another possibility consists in allowing cooling substances to escape locally in the outer area at the outer boundaries in such manner that more heat may be dissipated to this substance and thus to the surrounding atmosphere. Gel-like substances with high thermal capacity and preferably a high evaporation rate seem particularly suitable for this purpose. Gels are particularly suitable for realizing these embodiments because their gel-like consistency prevents the cooling, liquid components from flowing away too quickly. Because of the high thermal capacity of water, water-based gels represent a preferred option for realizing these embodiments, provided there are no considerations that would preclude such use, such as a strong chemical reaction with components of the galvanic cell.

1-14. (canceled)

15. An electrochemical energy store comprising:
at least one galvanic cell, wherein this galvanic cell contains or includes a component or device which causes the heat production inside the galvanic cell to be reduced at least temporarily and/or the heat dissipation from this cell to the surrounding atmosphere to be increased at least temporarily when a limit temperature inside the galvanic cell is at least locally exceeded, and thus also causes heat production inside the galvanic cell to fall to or below the level of heat dissipation from this cell beyond its spatial boundaries.

16. The electrochemical energy store as recited in claim 1, wherein the component or device that causes the heat production inside the galvanic cell to be reduced at least temporarily and/or the heat dissipation from this cell to the surrounding atmosphere to be increased at least temporarily when a limit temperature inside the galvanic cell is at least locally exceeded is a chemical substance or a mixture of substances that is located inside the galvanic cell.

17. The electrochemical energy store as recited in claim 15, wherein the component or device that causes the heat production inside the galvanic cell to be reduced at least temporarily and/or the heat dissipation from this cell to the surrounding atmosphere to be increased at least temporarily when a limit temperature inside the galvanic cell is at least locally exceeded is a structural component or device that is controlled by sensor signals.

18. The electrochemical energy store as recited in claim 15, wherein the at least temporary reduction in heat production inside the galvanic cell and/or the at least temporary increase in heat dissipation from this cell to the surrounding atmosphere is caused by at least a local influence of at least one chemical reaction and/or at least one substance transport action inside the galvanic cell by the component or device.

19. The electrochemical energy store as recited in claim 18, wherein at least one chemical reaction and/or at least one substance transport operation inside the galvanic cell is at least locally inhibited.

20. The electrochemical energy store as recited in claim 15, wherein the thermal conductivity in the interior of the galvanic cell is temporarily or permanently increased at least locally.

21. The electrochemical energy store as recited in claim 20, wherein materials whose thermal conductivity increases as the temperature rises are disposed inside the galvanic cell.

22. The electrochemical energy store as recited in claim 20, wherein the thermal conductivity inside the galvanic cell is temporarily or permanently increased at least locally by at least one heat pump disposed inside the galvanic cell.

23. The electrochemical energy store as recited in claim 22, wherein the heat pump is controlled by sensor signals that represent the temperatures measured in the interior of the cell.

24. A method for thermally stabilizing an electrochemical energy store including at least one galvanic cell, comprising
causing, via one component or one device of the galvanic cell, the heat production inside the galvanic cell to be reduced at least temporarily and/or the heat dissipation from this cell to the surrounding atmosphere to be increased at least temporarily when a limit temperature inside the galvanic cell is at least locally exceeded, thus also causing heat production inside the galvanic cell to fall to or below the level of heat dissipation from this cell beyond its spatial boundaries.

25. The method as recited in claim 24, wherein the at least temporary reduction of heat production inside the galvanic cell and/or the at least temporary increase in heat dissipation from this cell to its surroundings is caused by an at least local influence of at least one chemical reaction and/or at least one substance transport action in the interior of the galvanic cell by the component or device.

26. The method as recited in claim 24, wherein at least one chemical reaction and/or at least one substance transport action is inhibited at least locally in the interior of the galvanic cell.

27. The method as recited in any of claims 24, wherein the thermal conductivity in the interior of the galvanic cell is temporarily or permanently increased at least locally.

28. The method as recited in claim 27, wherein the thermal conductivity in the interior of the galvanic cell is temporarily or permanently increased at least locally by materials in the interior of the galvanic cell, the thermal conductivity which increases as the temperature rises.

29. The method as recited in claim 27, wherein the thermal conductivity in the interior of the galvanic cell is temporarily or permanently increased at least locally by a heat pump in the interior of the galvanic cell.

30. The method as recited in claim 29, wherein the heat pump is controlled by sensor signals representing temperatures that have been measured inside the cell.
